(19) United States
(12) Patent Application Publication
(10) Pub. No.: US 2007/0198752 A1
(43) Pub. Date: Aug. 23, 2007

(54) Modular machine and corresponding method for dynamically configuring the topology of said machine

(76) Inventors: Mikro Danz, Feucht (DE); Johannes Extra, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/594,479

(22) PCT Filed: Mar. 15, 2005
(86) PCT No.: PCT/EP05/51154

§ 371 Date: Sep. 28, 2006

(30) Foreign Application Priority Data
Mar. 29, 2004 (DE) 10 2004 015 240.3

(51) Int. Cl. G06F 3/00

(52) U.S. Cl. 710/8

(57) ABSTRACT

In one aspect, a method for dynamic configuration of a modular machine, whose modules are interconnected and connected to a control unit via a communications network is provided in order to facilitate the modification of a machine configuration in automated systems. According to the method, during the operation of the machine, one of the communications partners determines the communications partners in the communications network. The communications partner then generates a suitable communications configuration and activates said configuration. This permits the communications configuration or design to be automatically executed, even during the operation of the machine.

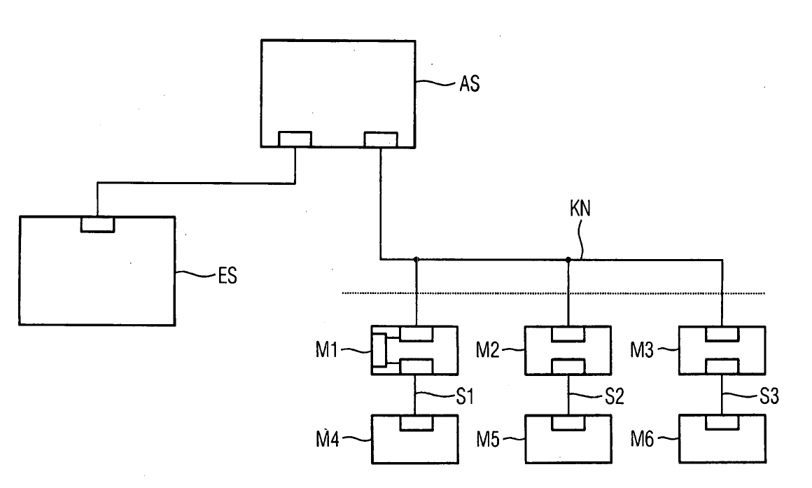

### CROSS REFERENCE TO RELATED APPLICATIONS

This application is the US National Stage of International Application No. PCT/EP2005/051154, filed Mar. 15, 2005 and claims the benefit thereof. The International Application claims the benefits of German application No. 102004015240.3 DE filed Mar. 24, 2004, both of the applications are incorporated by reference herein in their entirety.

### FIELD OF INVENTION

The present invention relates to a method for dynamically configuring a topology of a modular machine whose modules are connected to one another and to a control device via a communications network. The present invention additionally relates to a modular machine of this kind.

### BACKGROUND OF INVENTION

A modular machine for automated production processes is usually configured, in terms of its mode of operation, for the automation task to be solved. This means that, among other things, the individual modules of the machine are assigned corresponding tasks. This configuring is performed using an engineering system without taking the communications network topology of the machine modules into account. To ensure that the individual machine modules can also intercommunicate to perform their function, the communications topology is also determined at the engineering stage and a corresponding communications configuration is defined. This communications configuration is loaded into the automation system which constitutes the control device of the modular machine.

If the configuration of the machine, i.e. its modular structure, is then changed, this also generally results in a changed communications configuration. If a rigid topological communications configuration is used, this means than any successor of a communications partner (e.g. a replaced module) for which the address has been changed can no longer be communicated with, as the system no longer knows how it can be reached if necessary via other communications partners. The same problem arises if the connection of a communications partner to the communications network of a modular machine is re-arranged. Again the system (control device and other machine modules) no longer knows how the communications partner can be reached in the topology.

To solve this problem, in present systems the configuration, including the communications configuration, matching a changed topological machine structure is therefore loaded into the corresponding automation system and all the machine modules. However, this is a relatively complex and/or costly process and involves interrupting machine operation.

### SUMMARY OF INVENTION

An object of the present invention is therefore to make it easier to reconfigure a modular machine.

This object is achieved by a method for dynamically configuring a modular machine whose constituent modules are connected to one another and to a control device via a communications network, by determining the communications partners in the communications network by means of one of the communications partners while the machine is in operation, generating an appropriate communications configuration by means of one of the communications partners and activating the generated communications configuration during runtime of the machine.

There is additionally provided according to the present invention a modular machine having a plurality of machine modules, a control device for controlling the machine modules in an open- or closed-loop manner, and a communications network with which the control device and the machine modules are interconnected for communication, the communications partners being ascertainable in the communications network using one of the plurality of machine modules and/or the control device and an appropriate communications configuration being generatable and activatable during the machine runtime.

The inventive dynamic configuring of the topology of the communications network of the modular machine has the advantage that, when the communications topology is reconfigured, machine operation does not need to be interrupted and it is possible for the communications to be configured during the runtime of the machine.

In a preferred application, the modular machine according to the invention is incorporated in a production process, and generation of the communications configuration is initiated by an internal or external process event. A process event of this type can be an alarm signaling a new communications partner, an operator input or a change of a communications partner. This means that it is possible according to the “plug-and-play” philosophy for a machine module to be replaced or plugged into another socket during the runtime of the machine.

The generated communications configuration is preferably stored centrally in a server connected via the communications network or non-centrally in one of the communications partners. This means that the communications configuration is always accessible for reconfiguring.

The communications network can comprise at least one subnetwork with which a second machine module can be connected to a first machine module for communication, so that the second machine module is connected indirectly to the communications network via the first machine module. This means that the communications configuration also includes subnetworks which are not connected directly to the main network. In this way the communications partners of the subnetworks can be also detected for automatic, dynamic configuring.

A preferred method for putting a modular machine into service therefore begins with the step of configuring the interaction of the machine modules, prior to the startup stage of the modular machine, by means of an engineering system for an automation task to be solved without taking the communications topology of the individual machine modules into account, followed by the step of dynamically configuring the communications network with which the machine modules are interconnected, according to the above described configuration method. This considerably simplifies the engineering process prior to the machine startup stage.

### BRIEF DESCRIPTION OF THE DRAWING

The present invention will now be explained in greater detail with reference to the sole accompanying drawing which schematically illustrates the communications topology of a modular machine.

### DETAILED DESCRIPTION OF INVENTION

The exemplary embodiment described in greater detail below is a preferred embodiment of the present invention.

A flexible, modular machine typically consists of machine modules M1 to M6 as shown in the figure. The machine modules M1 to M3 are connected to a communications network KN. The possible separation between the machine modules and the communications network KN is indicated in the figure by a dotted line.

The machine modules M1 and M4 are interconnected via a communications subnetwork S1, the machine modules M2 and M5 via a communications subnetwork S2 and the machine modules M3 and M6 by a communications subnetwork S3. The subnetworks S1 to S3 are therefore connected only indirectly to the communications network KN via the relevant machine modules M1 to M3. Obviously the respective subnetworks S1 to S3 can each contain any number of further subnetworks. It is likewise conceivable for further modules to be connected to the modules M4 to M6 via additional subnetworks.

The modules M1 to M6 are controlled by an automation system AS via the communications network KN/S1 to S3. The automation system AS is connected for its part to an engineering system ES. A machine configuration created using the engineering system ES can therefore be stored in the automation system AS.

According to the invention, one of the communications partners of the communications network KN, in this case the machine module M1 is selected by way of example, is used to determine the communications partners connected to the communications network KN including its subnetworks S1 to S3 and to generate a corresponding communications configuration or parameterization. This configuration is then stored in the machine module M1 and activated during the runtime of the machine. It is therefore possible for one of the machine modules M1 to M6 to be replaced or replugged at any time without needing to stop the machine. The machine module M1 determines the communications configuration dynamically, e.g. by analyzing adjacencies between the communications partners or signal timings. In the present case, not only the modules M1 to M6 but also the automation system AS and the engineering system ES are regarded as communications partners.

However, the communications topology can also be determined alternatively or simultaneously by the automation system AS or another communications partner and a corresponding communications configuration generated and activated. A special server in which the communications configuration is stored and made available can likewise be connected to the communications network.

The configuring procedure is initiated e.g. by an operator input in the engineering system ES or plugging of a module M1 to M6 into the communications network KN or the corresponding subnetwork S1 to S3 or a process event, etc. Such an event triggers not only the automatic generation of the communications configuration but also, optionally, automatic activation of said communications configuration.

In order to organize the configuring procedure efficiently, only the changing communications partners are redrawn. Communications relationships of non-changing communications partners are retained. The only requirement for successful configuring is that at the time of communications configuring all the possible communications partners are known.

The dynamic configuring described in the selected example enables modular machines to be supported in respect of a flexible topological machine structure and any change to said machine structure at runtime.

1.-11. (canceled)

12. A method for dynamically configuring a modular machine having machine modules connected to one another and connected to a control device via a communications network, comprising:
determining a second communications partner in the communications network via a first communications partners while the second communications partner is in operation;
generating a suitable communications configuration via the first communications partner; and
activating the generated communications configuration during the runtime of the machine.

13. The method as claimed in claim 12, wherein the modular machine is incorporated in a production process and generation of the communications configuration is initiated by a process event.

14. The method as claimed in claim 13, wherein the process event is an internal event.

15. The method as claimed in claim 13, wherein the process event is an external event.

16. The method as claimed in claim 13, wherein the process event is an alarm signaling a new communications partner, an operator input or a change of a communications partner.

17. The method as claimed in claim 13, wherein the generated communications configuration is stored centrally in a server connected via the communications network or non-centrally in one of the communications partners.

18. The method as claimed in claim 12, wherein the communications network comprises a subnetwork with which a second machine module is connected to a first machine module for communication such that the second machine module is connected indirectly to the communications network via the first machine module.

19. A method for putting a modular machine having machine modules into service, comprising:
configuring an interaction of the machine modules prior to a startup of the modular machine via an engineering system for solving an automation task without taking into account the communications topology of the individual machine modules; and
dynamically configuring a communications network,
wherein the machine modules are interconnected

20. A modular machine, comprising
a plurality of machine modules;
a control device for controlling the machine modules in an open- or closed-loop manner; and
a communications network with which the control device and the machine modules are interconnected for communication,
wherein communications partners in the communications network are determined and a suitable communications configuration is generated and activated during runtime, and
wherein the communications partners are determine via one of the plurality of machine modules or via the control device.

21. The modular machine as claimed in claim 20, wherein the machine is incorporated in an automation process, the generation of the communications configuration triggerable by an internal or external process event.

22. The modular machine as claimed in claim 21, wherein the process event is an alarm signaling a new communications partner, an operator input or a change of a communications partner.

23. The modular machine as claimed in claim 22, wherein the generated communications configuration is stored centrally in a server connected via the communications network or non-centrally in one of the communications partners.

24. The modular machine as claimed in claim 22, wherein the communications network comprises a subnetwork with which a second machine module is connected to a first machine module for communication, so that the second machine module is connected indirectly to the communications network via the first machine module.
